(19) United States
(12) Patent Application Publication
(10) Pub. No.: US 2013/0279306 A1
(43) Pub. Date: Oct. 24, 2013

(54) Internet Wearables

(71) Applicant: Leshana Jackson, Chicago, IL (US)

(72) Inventor: Leshana Jackson, Chicago, IL (US)

(21) Appl. No.: 13/779,572

(22) Filed: Feb. 27, 2013

Related U.S. Application Data
(60) Provisional application No. 61/634,342, filed on Feb. 27, 2012.

(51) Int. Cl. G04G 99/00

(52) U.S. Cl. CPC G04G 99/00
USPC 368/282

(57) ABSTRACT

The invention provides a line of specially designed wristwatches equipped with Internet access capability to provide users with a simple and convenient means of accessing the Internet regardless of location. Configured to be worn around the wrist, the Internet Wearable watch comprises an attractive leather or woven nylon wristband in sizes appropriate for men, women and children.

### CLAIM OF PRIORITY

This patent application claims priority under 35 USC 119(e)(1) from U.S. Provisional Patent Application Ser. No. 61/634,342 filed Feb. 27, 2012, of common inventorship herewith entitled, “Internet Wearables.”

### FIELD OF THE INVENTION

The present invention pertains to the field of wristwatches, and more specifically to the field of wristwatches with communication capability.

### BACKGROUND OF THE INVENTION

The prior art has put forth several designs for wristwatches with communication capability. Among these are:

U.S. Pat. No. 6,525,997 to Chanrasekhar Narayanaswami and Mandayam T. Raghunath describes a wristwatch mobile computing appliance with a high resolution display that is capable of wirelessly accessing information from a network and variety of other devices. The mobile computing appliance includes a user interface that includes software mechanisms for enabling watch face orientation in either of circular and elliptical modes, and enables further display of textual content in remaining portions of the display when in either circular and elliptical mode.

U.S. Pat. No. 6,703,930 to Davey N. Skinner describes methods and apparatus for detecting the occurrence of an event and notifying a user of the event as well as the nature of the event. The user can be in practically any local or remote location relative to the location of the event. The user establishes criteria in accordance with which an alerting message is routed to any of various destinations which can be various types of communication devices monitored by the user. The user also establishes criteria in accordance with which the mode of the alerting message is presented to the user.

U.S. Pat. No. 7,433,273 to Isao Oguchi and Teruhiko Fujisawa describes an electronic timepiece with wireless information function. This timepiece is small, has good reception performance and has a construction that improves the freedom of design. Antennae are disposed inside a short cylindrically shaped metal case one of which both ends along its cylindrical axis are open with the axes of the antennae substantially parallel to the cylindrical axis of the case. A magnetic field passing part capable of passing the magnetic field of radio waves is disposed in an open side of the case along an extension of the antenna axis. Radio waves entering from the open side of the case can therefore be received by the antenna. The case is manufactured from metal, increasing the freedom of design and making it possible to improve the appearance.

None of these prior art references describe the present invention.

### SUMMARY OF THE INVENTION

It is an object of the present invention to provide a wristwatch equipped with Internet access.

### BRIEF DESCRIPTION OF THE DRAWINGS

FIG. 1 is a front perspective view showing an LCD touch screen on a wristband.

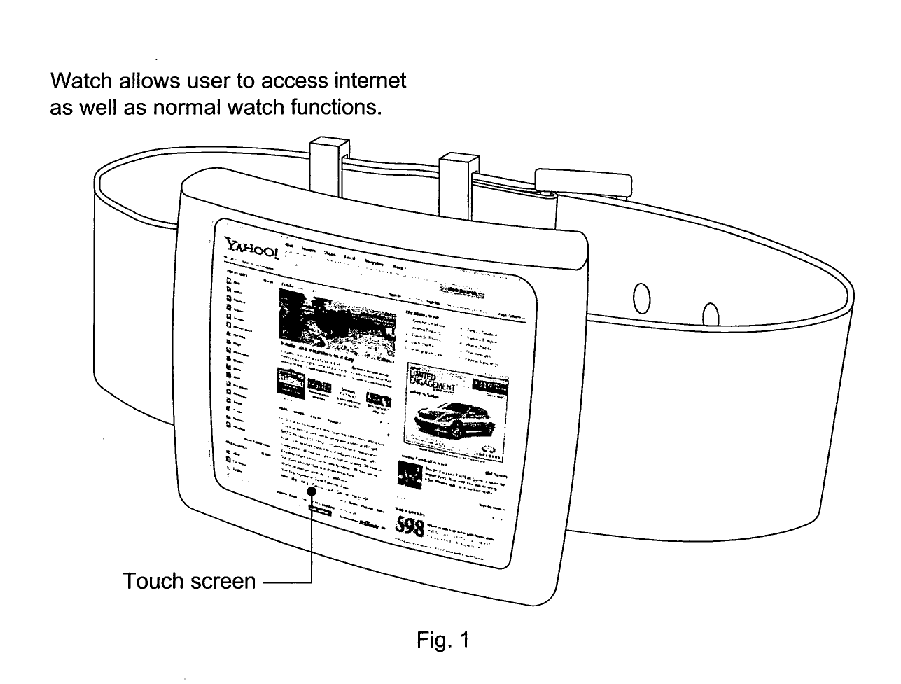

### DETAILED DESCRIPTION OF THE INVENTION

The development of the Internet began in the late nineteen hundred sixties through government funded projects to demonstrate and perform remote access data processing, enabling researchers to use off site computers and computer networks as if they were accessible locally. Although these networks initially were intended to support government and academic research, they were transformed into the medium known today as the Internet when their public and commercial value was realized. In addition to the privatization of these networks and the construction of new networks, advances in computing technology fostered the Internet's growth. A hypertext programming system, which automatically links digitized text to other information sources, made possible the information retrieval method known as the World Wide Web. Advancements in the processing capability of personal computers and the development of browser software also greatly facilitated public use of the Internet. By nineteen hundred ninety five, a major surge occurred in Internet use that continues unabated today. From exploring personal interests and researching material for school to compiling the latest data for professional reports and teleconferencing, the Internet has become more a necessity than a luxury in today's technologically advancing world.

The present invention, hereinafter referred to as the Internet Wearables, is a line of specially designed wristwatches equipped with Internet access capability. Design intent is to provide Web aficionados with a simple and convenient means of accessing the Internet regardless of location. Configured to be worn around the wrist, the Internet Wearable watch comprises an attractive leather or woven nylon wristband in sizes appropriate for men, women and children. This band extends from either side of a rectangular primary unit and is raised approximately two inches above the band. The top of the Internet Wearable watch comprises a rectangular LCD, liquid crystal display, screen measuring approximately two to three inches in width. This screen is augmented with the numbers twelve, three, six and nine, positioned in the same places as on a clock face. With this clock face, the Internet Wearable functions as a practical timekeeper.

The Internet Wearable also functions as a connecting device to the Internet. Directly below the LCD screen, a small alphanumeric keypad facilitates touch commands that range from typing in a Web address to composing Twitter and Facebook statuses to writing full emails. To connect to the Internet, the Internet Wearable is equipped with a wireless Internet card within the unit that works similar to other wireless devices such as cell phones and PDAs, by utilizing radio waves to access the Internet. A WiFi hot spot, usually a wireless router or access point, first receives information from the Internet through wires. The WiFi then translates that data from the binary form, or the computer code of Is and Os, into radio waves. These radio waves then are broadcast the surrounding area. Wireless signals typically travel between approximately seventy five feet and one hundred fifty feet. In a wide open area with no obstacles, radio waves have been known to transmit approximately one thousand feet, even up to a mile. Wireless Internet cards within the range of the radio signal pick up the signal using a tiny antenna and translate it back into binary code for the Internet Wearable to read. The process works in the opposite direction with the card translating the Internet Wearables' information into radio waves to send to the router where it is put back into binary form and sent to the Internet over the wires. Internet Wearable users are able to go online virtually anywhere whether they are on a college campus, sipping a gourmet coffee at a coffee shop or stuck in rush hour traffic.

A line of accessories that are aesthetically pleasing and practical to use, the Internet Wearables provides users to sport a fashionable and functional wristwatch that also ensures easy and expedient access to the Internet. Fully developed and affordably priced, the present invention will well received by the general consumer populace.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A wristwatch device equipped with Internet access, comprising a wristband configured to be worn around the wrist, wherein the wrist band extends from each side of a rectangular primary unit and is raised approximately two inches above the band, wherein the top of the primary unit comprises a rectangular LCD, liquid crystal display, screen measuring approximately two to three inches in width, and wherein the LCD display comprises a screen having the numbers twelve, three, six and nine, positioned in the same places as on a clock face.

2. The device of claim 1 wherein the band comprises leather.

3. The device of claim 2 wherein the band comprises woven nylon.

4. The device of claim 1 wherein internet access is provided by an Internet card.
